(19) United States
(12) Patent Application Publication
(10) Pub. No.: US 2025/0278650 A1
(43) Pub. Date: Sep. 4, 2025

(54) RARE EVENTS ESTIMATION

(71) Applicant: SRI International, Menlo Park, CA (US)

(72) Inventors: Tuhin Sahai, San Francisco, CA (US); Ahmed Aloui, Durham, NC (US); Susmit Kumar Jha, Redwood City, CA (US)

(21) Appl. No.: 18/985,950

(22) Filed: Dec. 18, 2024

Related U.S. Application Data
(60) Provisional application No. 63/559,679, filed on Feb. 29, 2024.

(51) Int. Cl. G06N 7/01; G06N 20/00

(52) U.S. Cl. CPC G06N 7/01; G06N 20/00

(57) ABSTRACT

In an example, a method for estimation of the probability of rare events includes determining a control function that guides an Artificial Intelligence (AI) agent towards a rare region of state space; modifying, using the control function, dynamics of the behavior of the AI agent to generate modified dynamics; simulating behavior of the AI agent using the modified dynamics to generate one or more samples that are more likely to enter the rare region of the state space; assigning a weight to each of the one or more generated samples; and estimating probability of one or more rare events in the behavior of the AI agent by fitting a distribution describing behavior of the one or more rare events to the one or more weighted samples.

This application claims the benefit of U.S. Patent Application 63/559,679, filed Feb. 29, 2024, which is incorporated by reference herein in its entirety.

### TECHNICAL FIELD

This disclosure is related to machine learning systems, and more specifically to rare events estimation for machine learning systems.

### BACKGROUND

As machine learning systems, which can include autonomous systems and machine learning models, become increasingly pervasive, ensuring safety and reliability of such systems and models becomes increasingly important. However, verifying these systems in a way that guarantees safety across diverse real-world scenarios remains a significant challenge. Traditional verification approaches, such as formal methods, constructing safe sets, and model checking, have limitations when applied to complex, real-world systems. These approaches often struggle to scale to the complexity of modern machine learning models and interactions of machine learning models with the physical world. Traditional verification approaches often rely on strong assumptions about the environment and the behavior of the systems, which may not hold in real-world scenarios.

### SUMMARY

In general, techniques are described for estimating rare events for machine learning systems. Traditional verification approaches are designed for specific types of machine learning systems, such as autonomous systems or Machine Learning (ML) models, making these approaches less versatile. Autonomous systems may exhibit unexpected behavior in edge cases or when faced with unforeseen circumstances. For example, malicious actors may manipulate training data or ML models to induce incorrect behavior, compromising safety and security.

In the context of risk factors, Monte Carlo simulations are a tool commonly used for modeling uncertainty and risk, but such simulations may face significant limitations when applied to rare events or low-probability failure modes. To accurately estimate the probability of rare events, a massive number of simulations may be required. In general, large sample sizes may be computationally expensive, especially for complex ML models.

In the realm of Artificial Intelligence (AI), as the number of Monte Carlo simulations increases, so does the computational time, making such simulations impractical for real-time or near-real-time applications. When dealing with low-probability events, the statistical variance of the estimated probabilities may be very high. In other words, the results may be unreliable and sensitive to small changes in the input parameters or the random number generator. Achieving convergence of the simulation results may be difficult, especially when the desired level of precision is high.

With the increasing complexity and autonomy of systems, especially those powered by machine learning, quantifying and mitigating the risk of unexpected or harmful behavior presents a significant challenge. However, traditional approaches often fall short in accurately assessing the aforementioned risks, particularly for low-probability (“rare”) events. To address this, the disclosed techniques for estimating rare events may employ statistical methods to quantify the risk of unexpected or harmful behavior of systems. By analyzing the probability distribution of the behavior of the system, the techniques may enable identification of potential failure modes and estimation of likelihood of the potential failure modes.

Reinforcement Learning (RL) is a powerful technique for training autonomous systems to make optimal decisions. However, due to the inherent stochastic nature of RL, RL systems may occasionally exhibit unexpected behavior. Such unpredictability introduces difficulties for guaranteeing safety and reliability.

As described herein, by analyzing historical data for the RL system, the disclosed techniques for estimating rare events may identify patterns that deviate from normal behavior. In some aspects, the RL system may employ statistical models that may be used to estimate the probability of the rare events occurring. Once the probabilities are estimated, the disclosed techniques may assess the potential consequences of these rare events to quantify the overall risk. In another aspect, based on the risk assessment, the machine learning system may implement strategies to reduce the likelihood of these events or mitigate impact of these events.

The techniques may provide one or more technical advantages that realize at least one practical application. For example, the techniques may enable the accurate estimation of failure and the failure modalities in a manner that is based on the presence of internal (to the ML system) and external (environmental) uncertainties. As another example, the techniques may enable detecting poisoned machine learning models and/or RL policies due, for instance, to intentionally or inadvertently faulty training data or RL policy configurations. As another example, the disclosed techniques may provide risk management in AI decision-making. By identifying potential risks before these risks materialize, organizations may take proactive steps to mitigate these risks. In some cases, by reducing the likelihood of unexpected behavior, machine learning systems implementing the disclosed techniques may be made safer and more reliable. A quantitative understanding of risk may inform decision-making processes, such as the manner of deployment of autonomous systems in critical infrastructure. This impact can be measured when deploying these systems and finding alignment with the predicted probabilities for these failure modes. This can have potential benefits in the real-world use of autonomous systems such as self-driving cars, autonomous UAVs, and software based algorithmic trading, for instance.

In an example, a method for estimation of the probability of rare events includes determining a control function that guides an Artificial Intelligence (AI) agent towards a rare region of state space; modifying, using the control function, dynamics of the behavior of the AI agent to generate modified dynamics; simulating behavior of the AI agent using the modified dynamics to generate one or more samples that are more likely to enter the rare region of the state space; assigning a weight to each of the one or more generated samples; and estimating probability of one or more rare events in the behavior of the AI agent by fitting a distribution describing behavior of the one or more rare events to the one or more weighted samples.

In an example, a computing system for estimation of the probability of rare events includes: processing circuitry in communication with storage media, the processing circuitry configured to execute a machine learning system comprising the AI agent, the machine learning system configured to: determine a control function that guides an Artificial Intelligence (AI) agent towards a rare region of state space; modify, using the control function, dynamics of the behavior of the AI agent to generate modified dynamics; simulate behavior of the AI agent using the modified dynamics to generate one or more samples that are more likely to enter the rare region of the state space; assign a weight to each of the one or more generated samples; and estimate probability of one or more rare events in the behavior of the AI agent by fitting a distribution describing behavior of the one or more rare events to the one or more weighted samples.

In an example, non-transitory computer-readable storage media having instructions encoded thereon for estimation of the probability of rare events, the instructions configured to cause processing circuitry to: determine a control function that guides an Artificial Intelligence (AI) agent towards a rare region of state space; modify, using the control function, dynamics of the behavior of the AI agent to generate modified dynamics; simulate behavior of the AI agent using the modified dynamics to generate one or more samples that are more likely to enter the rare region of the state space; assign a weight to each of the one or more generated samples; and estimate probability of one or more rare events in the behavior of the AI agent by fitting a distribution describing behavior of the one or more rare events to the one or more weighted samples.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 illustrates an example machine learning system and rare events estimation module, in accordance with the techniques of the disclosure.

FIG. 2 is a detailed block diagram illustrating an example computing system, in accordance with the techniques of the disclosure.

FIGS. 3A and 3B are graphs illustrating the computational challenge of simulating rare events.

FIG. 4 illustrates static importance sampling, according to techniques described in this disclosure.

FIG. 5 illustrates importance sampling for diffusions, according to techniques described in this disclosure.

FIG. 6 illustrates comparison of dynamic importance sampling in normal and non-normal systems, according to techniques described in this disclosure.

FIG. 7 is a flowchart illustrating an example mode of operation for a reinforcement learning system, according to techniques described in this disclosure.

Like reference characters refer to like elements throughout the figures and description.

### DETAILED DESCRIPTION

Cyber-physical systems (CPS) are complex systems that may integrate computational and physical components. Given the increasing complexity and reliance on machine learning of CPS, ensuring the safety and reliability of such systems may be important. However, quantifying the probability of rare events, such as system failures or security breaches, poses a significant challenge. Rare event estimation techniques may be designed to accurately assess the likelihood of low-probability events. By applying the rare event estimation techniques to CPS, the disclosed system may pinpoint specific scenarios that could lead to system failure. Additionally, the disclosed techniques may estimate the probability and impact of the system failures. In other words, the disclosed techniques may inform design decisions to improve system resilience and safety.

The integration of AI into CPS may introduce new vulnerabilities. The rare event estimation techniques may be used to consider the potential risks of AI backdoor trojans, which may manipulate system behavior, and bio attacks, which could exploit biological vulnerabilities in CPS. To evaluate rare events in autonomous vehicles, simulations may offer a safer and more controlled environment. By conducting extensive simulations, system designers may identify potential failure scenarios and may assess impact of these scenarios without endangering real-world systems.

In one non-limiting example, a Machine Learning (ML) system may leverage advanced statistical techniques to address the challenges of rare event estimation in CPS. In one example, the disclosed techniques may involve biasing the simulation process to focus on regions of the parameter space that are more likely to lead to rare events.

The disclosed techniques are applicable to a wide range of machine learning systems, including CPS. For example, the disclosed system may estimate the probability of accidents or system failures in autonomous vehicles. In many real-world scenarios, the disclosed techniques may assess the risk of power outages or cyberattacks on smart grids. As another non-limiting example, the disclosed techniques may evaluate the likelihood of medical device malfunctions or adverse patient outcomes. Even AI models designed to be safe and harmless may have vulnerabilities or weaknesses that could be exploited under specific circumstances. Rare/uncommon behaviors are behaviors that deviate from the typical responses or actions of the AI. Rare/uncommon behaviors could be caused by specific prompts, inputs, or edge cases that the model has not been adequately trained on. There may be safety mechanisms built into AI models to prevent the AI models from generating harmful or unsafe content. However, rare/uncommon behaviors may sometimes bypass these guardrails. Red-teaming is a security practice where individuals or teams try to identify vulnerabilities in a system by simulating attacks. In the context of AI, red-teaming may involve trying to find ways to make the AI behave in unintended or harmful ways. For example, an AI agent may typically refuse to provide instructions for creating a harmful substance. However, a rare/uncommon behavior may be discovered where the AI may provide such harmful instructions when prompted with a specific, carefully crafted query. This could be a vulnerability that may be exploited by malicious actors. By identifying and understanding these rare behaviors, developers and researchers may work to strengthen the safety and security of AI systems.

Rare events, by definition, are infrequent or low probability occurrences. This makes it difficult to directly observe and analyze them. However, understanding the underlying mechanisms that lead to rare events is important for improving the safety and reliability of complex systems like CPS.

The disclosed system may infer information about rare events from the observed normal behavior of an Artificial Intelligence (AI) agent. This may be achieved through a combination of statistical techniques and machine learning algorithms. By intentionally introducing perturbations or modifications to the environment of the RL system, the disclosed techniques may create scenarios that are more likely to trigger rare events. The created scenarios may be designed based on domain knowledge or through systematic exploration of the state space of the AI agent. The disclosed system may employ importance sampling, which is the statistical technique that involves biasing the sampling process to focus on regions of the parameter space that are more likely to lead to rare events.

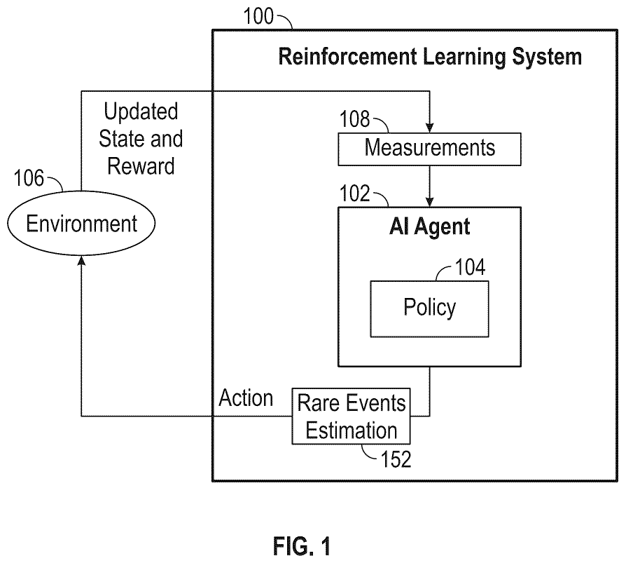

FIG. 1 illustrates an example machine learning system and rare events estimation module, in accordance with the techniques of the disclosure. Reinforcement learning system 100 may represent, for example, an autonomous vehicle, a trading or portfolio management algorithm, an industrial robot, a gaming system, a healthcare system for, e.g., treatment optimization or drug discovery, a supply chain management system, a natural language processing (NLP) system, a marketing or advertising system, or other system that operates at least semi-autonomously according to an RL algorithm.

Reinforcement learning system 100 trains AI agent to interact with environment 106. Reinforcement learning system 100 may include AI agent 102 that determines actions based on a policy 104. Each time an action is determined, it is output to an environment 106 being controlled by AI agent 102. The action may update a state of environment 106. The updated state may be returned to reinforcement learning system 100 along with an associated reward for the action. The received information may be used by reinforcement learning system 100 to determine the next action. In general, the reward may be a numerical value. The reward may be based on any event or aspect of environment 106. For example, the reward may indicate whether AI agent 102 has accomplished a task (e.g., navigating to a target location in environment 106) or the progress of AI agent 102 towards accomplishing a task.

Policy 104 may define how the system performs actions based on the state of environment 106. As reinforcement learning system 100 is trained based on a set of measurements 108, policy 104 followed by AI agent 102 may be updated by assessing the value of actions according to an approximate value function, or return function to improve the expected return from the actions taken by policy 104. This is typically achieved by a combination of prediction and control to assess the success of the actions performed by AI agent 102, sometimes referred to as the “return.” The return may be calculated based on the rewards received following a given action. For instance, the return might be an accumulation of multiple reward values over multiple time steps.

In an aspect, the state space, action space, transition function, and reward function may be derived from a domain model. A domain model is a representation of the knowledge about a particular domain. The domain model may be represented in a variety of ways, such as, but not limited to a set of rules, a data representation, a graph, or a machine learning framework such as a neural network. The state space may be the set of all possible states that reinforcement learning system 100 can be in. As reinforcement learning system 100 explores (visits) the state space, the system may learn about the relationships between the different states, referred to herein as explored state space.

AI agent 102 may perform a first action within environment 106. This action can be anything, such as moving to a new location, taking a measurement, or interacting with an object. Next, reinforcement learning system 100 may obtain one or more measurements from environment 106. These measurements 108 (collectively referred to as “experiences”) may be used to update the topology of the explored state space. Next, reinforcement learning system 100 may update the topology of the explored state space of a domain model for the environment based at least in part on the one or more measurements. For example, if a robot is exploring a new environment, the robot may use sensors to collect measurements of surroundings. These measurements may be used to create a state space that represents all of the possible configurations of the robot and the corresponding environment (e.g., environment 106). As the robot explores, the robot may collect new measurements and use them to update the state space. The update may involve adding new states to the state space, removing states that are no longer possible, or updating the weights of connections between states. The topology of the explored state space may be a representation of the relationships between different states of the domain model. The measurements may be used to update the values associated with each of the states in the topology. In an aspect, reinforcement learning system 100 may select, based at least in part on the updated topology, a second action to be performed by AI agent 102 within environment 106. The second action may be chosen in a way that is likely to maximize the reward that reinforcement learning system 100 receives and taking rare events estimation into consideration, as described below. In an aspect, the second action may be chosen based on policy 104. Next, agent 102 may perform the second action within environment 106. As shown in FIG. 1, the process may be repeated, with reinforcement learning system 100 continuously updating its knowledge of environment 106 and selecting actions in a way that maximizes its reward, while also considering the risk associated with rare events.

In other words, when AI agent 102 performs a number of actions within environment 106, reinforcement learning system 100 may be exploring the state space of the domain model. The state space may be the set of all possible states that reinforcement learning system 100 can be in. As reinforcement learning system 100 explores the state space, the system may learn about the relationships between the different states. This knowledge may be used by reinforcement learning system 100 to generate and/or update the topology of the explored state space. The topology of the explored state space is a representation of the relationships between the different states. The topology may be represented as a graph, with each state represented as a node and the edges between the nodes representing the possible transitions between states. The topology may be used to understand the structure of the state space and to plan future actions. This knowledge may be used by reinforcement learning system 100 to solve a variety of problems, such as, but not limited to, finding the shortest path between two states, finding the best way to avoid obstacles, and playing games.

As described herein, actions attributed to an AI agent 102, RL system 100, or other system may include AI agent 102 causing or otherwise interacting with some other system to perform such actions. For example, a description of AI agent 102 or RL system 100 “performing” an action encompasses an action of AI agent 102 or RL system 100 to cause a robot or other system to perform the action. As another example, AI agent 102 or RL system 100 “obtaining” a measurement encompasses AI agent 102 receiving an indication of a measurement taken by a sensor of a robot or other system.

In accordance with the techniques described herein, rare events estimation module 152 estimates probabilities of rare events for a machine learning system (RL system 100 in the example of FIG. 1).

In some examples, rare events estimation module 152 of the RL system 100 may actively modify environment 106 to create situations that are more likely to trigger failure modes. In the context of AI decision-making, these proactive techniques may allow for a more controlled and targeted analysis. In an aspect, the rare events estimation module 152 may employ probabilistic techniques, such as, but not limited to importance sampling and Girsanov change of measure to enhance the likelihood of observing rare events (failures) within the manipulated environment 106.

By strategically weighting certain outcomes, the RL system 100 may focus on critical scenarios that might otherwise be overlooked. Extreme Value Theory (EVT) is a statistical framework designed to analyze extreme (rare) events. In this context, rare events estimation module 152 may use EVT to extrapolate from the bulk of the normal behavior of AI agent 102 to the tail of the distribution, where rare failures occur. EVT may allow for more accurate predictions of extreme events. For example, the disclosed techniques may be integrated into rare events estimation module 152 as a mathematical package. The rare events estimation module 152 may gather data on typical behavior of AI agent 102, which may then be analyzed using the disclosed techniques. In an example, by applying importance sampling and EVT, the rare events estimation module 152 may pinpoint scenarios that are likely to lead to failures of AI agent 102.

In an example, the application of the disclosed technique to autonomous systems may be a significant step towards safe and reliable operation of the autonomous systems. By proactively identifying and quantifying potential failure modes, even before they occur, the disclosed techniques may enhance the overall safety and trustworthiness of autonomous systems. The RL system 100 may actively simulate and analyze various scenarios, including extreme/rare events, to identify potential vulnerabilities and failure modes. This proactive approach may allow for early detection and mitigation of potential issues, significantly reducing the risk of accidents or system failures. By leveraging statistical techniques like EVT, the rare events estimation module 152 may provide quantitative estimates of the likelihood and severity of different failure modes. The quantitative estimates may enable a data-driven assessment of risk, helping the RL system 100 to prioritize safety measures and allocate resources effectively. The employment of mathematical techniques, such as, but not limited to, importance sampling and Girsanov change of measure, may provide theoretical guarantees on the accuracy of the risk assessments. This kind of assurance may provide confidence in the reliability of the predictions and recommendations of the RL system 100

In traditional decision-making, AI agent 102 may learn from real-world data and may adapt to changing conditions, continuously improving ability of AI agent 102 to identify and mitigate risks. Such adaptability may enable AI agent 102 to stay ahead of potential threats and maintain a high level of safety. In a concrete example, in the context of autonomous vehicles, by simulating various traffic conditions and analyzing historical data, the RL system 100 may identify rare but high-risk scenarios that could lead to accidents. Accordingly, the RL system 100 may calculate the probability and severity of potential accidents associated with different maneuvers, such as lane changes or turns.

In summary, FIG. 1 illustrates reinforcement learning system 100 configured to estimate the probability of rare events in complex systems, particularly those involving AI agents, which may include the steps described below. Reinforcement learning system 100 leverages techniques from control theory, statistics, and machine learning to increase the likelihood of observing these rare events. The rare events estimation module 152 may first identify the specific region in the state space where the rare events are likely to occur. This step may involve analyzing historical data, domain expertise, or statistical techniques. The rare events estimation module 152 may determine a control function that guides AI agent 102 towards this rare region. The control function may act as a “steering wheel,” directing the behavior of AI agent 102 to explore the less frequent areas of the state space. Next, the rare events estimation module 152 may alter the original dynamics of the behavior of AI agent 102 by incorporating the control function. This modification may bias the actions of AI agent 102 to increase the probability of entering the rare region. The rare events estimation module 152 may influence the behavior of AI agent 102 using the modified dynamics to simulate behavior of AI agent 102 to produce events that can be sampled to generate one or more samples. This simulation may generate multiple trajectories or sample paths. Due to the modified dynamics, these simulations are more likely to produce samples that visit the rare region. The rare events estimation module 152 may assign weights to each generated sample. The assigned weights may account for the fact that the samples were generated from a modified probability distribution. This may be important for accurate probability estimation. The Generalized Extreme Value (GEV) distribution is universal distribution and statistical model that may be used to analyze extreme events. Hereinafter, the GEV distribution is used to describe the inventive techniques.

The rare events estimation module 152 may fit the GEV distribution to the weighted samples. This step may involve estimating the parameters of the distribution that best describe the tail behavior of the rare events. In an aspect, the rare events estimation module 152 may use the fitted GEV distribution to estimate the probability of various rare events, such as, but not limited to, the probability of exceeding a specific threshold or the probability of a certain extreme event occurring within a given time frame.

The disclosed techniques may enable prediction and prevention of failures of AI agent 102, even in scenarios where direct observation of failures is limited. The disclosed techniques may extract valuable insights from normal behavior of AI agent 102 to identify potential failure sequences.

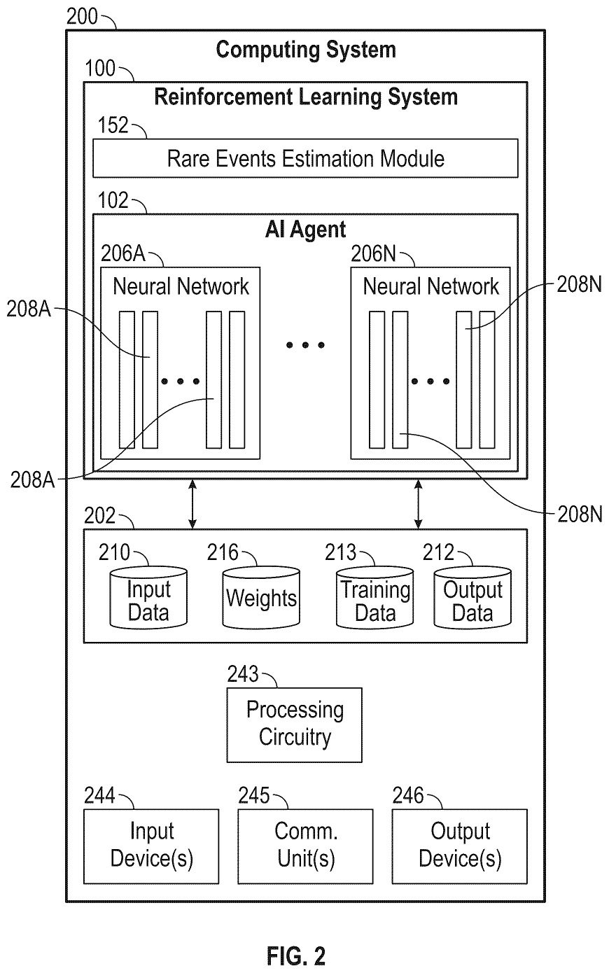

FIG. 2 is a block diagram illustrating an example computing system 200. In an aspect, computing system 200 may comprise an instance of the RL system 100. As shown, computing system 200 includes processing circuitry 243 and memory 202 for executing a reinforcement learning system 100 having one or more neural networks 206A-206N (collectively, “NNs 206”) comprising respective sets of layers 208A-208N (collectively, “layers 208”). Each of NNs 208 may comprise various types of neural networks, such as, but not limited to, recursive neural networks (RNNs), convolutional neural networks (CNNs) and deep neural networks (DNNs). In an aspect, any of NNs 206 may comprise an example instance and implementation of AI agent 102 shown in FIG. 1. However, implementations of AI agent 102 using machine learning models other than NNs may be used. For example, AI agent 102 may implement reinforcement learning using tabular models, linear models such as linear function approximators, decision trees, Gaussian processes, evolutionary algorithms, probabilistic models such as Bayesian networks or Hidden Markov models, etc. Reinforcement learning system 100 may further include one or more rare events estimation module 152 described below.

Computing system 200 may be implemented as any suitable computing system, such as a controller, one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. Computing system 200 may be a separate or integrated controller for any of the examples of RL systems described above with respect to FIG. 1 (e.g., an industrial robot). Computing system 200 may represent an instance of RL system 100 of FIG. 1.

In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., NNs 206, rare events estimation module 152), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute reinforcement learning system 100 using virtualization modules, such as a virtual machine or container executing on underlying hardware. One or more of such modules may execute as one or more services of an operating system or computing platform. Aspects of reinforcement learning system 100 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, rare events estimation module 152 may receive input data 210 and may generate output data 212. Input data 210 and output data 212 may contain various types of information. For example, input data 210 may include a sampling distribution. Output data 212 may include probability and severity of different failure modes (e.g., rare events), for example.

Each set of layers 208 may include a respective set of artificial neurons. Layers 208A for example, may include an input layer, a feature layer, an output layer, and one or more hidden layers. Layers 208 may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer.

Each input of each artificial neuron in each layer of the sets of layers 208 is associated with a corresponding weight in weights 216. Various activation functions are known in the art, such as Rectified Linear Unit (ReLU), TanH, Sigmoid, and so on.

Reinforcement learning system 100 may process training data 213 to train the NN 206, in accordance with techniques described herein. For example, reinforcement learning system 100 may apply an end-to-end training method that includes processing training data 213. Reinforcement learning system 100 may process input data 210 to compute one or more rare events as described below.

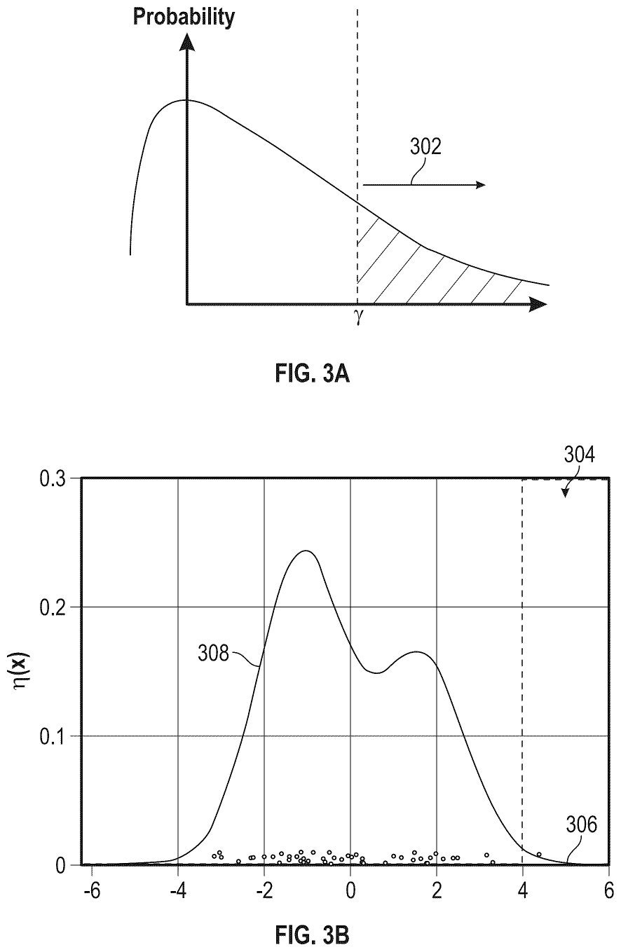

In an aspect, the disclosed techniques offer a significant advancement in the field of RL by addressing an important challenge: ensuring the safety and reliability of AI agent 102 in real-world applications. By analyzing the normal behavior of AI agent 102, the rare events estimation module 152 may pinpoint scenarios that are likely to lead to failures. Quantifying these failure probabilities 302 (shown in FIG. 3A) may provide a clear understanding of the limitations and potential risks of AI agent 102. The identified weak spots may be used to train AI agent 102 to avoid these risky behaviors. By focusing on mitigating the identified failure modes, AI agent 102 may become more robust and reliable. A better understanding of failure modes may lead to more effective training and optimization techniques. By addressing the root causes of failures, the overall performance of AI agent 102 may be significantly improved.

The ability to quantify and mitigate risks described by the present disclosure may be important for deploying AI agents 102 in real-world settings. By providing theoretical guarantees on the accuracy of risk assessments, the rare events estimation module 152 may enhance the confidence in the deployment of AI agent 102.

In one example, autonomous vehicles employing the RL system 100 shown in FIG. 2 may identify and mitigate potential collision scenarios. The autonomous vehicles may also better optimize driving strategies to reduce accidents. In another non-limiting example, the disclosed techniques may enhance flight safety of autonomous UAVs by avoiding hazardous conditions. For AI agents 102 operating as UAVs, the RL system 100 may improve navigation and obstacle avoidance.

Predicting rare events, or low-probability, high-consequence events, may be a complex task with significant implications across various industries. These high-consequence events, such as catastrophic failures, natural disasters, or cyberattacks, may have devastating consequences. The computational cost of simulating rare events may scale exponentially with the probability of occurrence of the rare events. In other words, as the probability of a failure decreases, the computational effort needed to simulate such failures may increase dramatically.

Rare events, by definition, are low probability events that occur infrequently. This lack of data may complicate development of accurate statistical models.

Many real-world systems are highly complex, with numerous interacting components. This complexity may make it difficult to identify and quantify the factors that contribute to rare events.

Accurate prediction of rare events may be important for identifying potential weaknesses in designs. Accurate prediction of rare events may better optimize RL system 100 to reduce risk. Accurate prediction of rare events may also quantify the likelihood and potential impact of failures. In response, RL system 100 may prioritize risk mitigation strategies. As yet another example, accurate prediction of rare events may enable better informed decisions about investments, maintenance, and policy.

Accurate prediction of rare events may also ensure the safety of critical systems, such as, but not limited to, various systems in aerospace, nuclear power, and healthcare. To overcome the challenges associated with predicting rare events, the disclosed techniques may utilize statistical models to analyze historical data and identify patterns.

In an aspect, the rare events estimation module 152 may simulate complex systems to explore potential failure modes. Importantly, AI agent 102 may employ machine learning models (e.g., NNs 206) to learn from data and make predictions.

The CPS are ubiquitous, from autonomous vehicles to smart grids, and reliability of such systems may be paramount. While existing rare event prediction approaches, such as rare event simulation, may be adapted to CPS, these approaches face significant challenges. In other words, CPS often involve a combination of continuous (physical) and discrete (digital) states. This hybrid nature of CPS may complicate the application of traditional approaches. Many CPS are complex and difficult to model explicitly. This may create challenges to directly apply techniques that rely on detailed system knowledge.

To overcome the aforementioned challenges, the traditional approaches typically combine continuous and discrete simulation methods to model CPS behavior. The conventional approaches may also leverage techniques like Monte Carlo simulation and Markov Chain Monte Carlo to sample from the state space.

As shown in FIG. 2, the disclosed techniques may be applied to AI agent 102 and/or other ML models. Such application may entail identifying potential vulnerabilities in AI agent 102 and/or ML models, such as adversarial attacks or model degradation over time.

The disclosed techniques may also be applied to other CPS systems, such as autonomous systems (e.g., mobile robots/UAVs). This application may include predicting potential failures in the sensors, actuators, or control systems of autonomous robots or drones. The disclosed techniques may also be applied to radar systems. In one example, the disclosed techniques may predict the likelihood of system failures or degradation due to factors such as, but not limited to, component wear, environmental conditions, or software bugs.

However, the application of disclosed techniques is not limited to CPS. In one case, the disclosed techniques may predict the probability of extreme weather events, such as, but not limited to, hurricanes, tornadoes, or floods based on weather data and models. The disclosed techniques may also assess the risk of earthquakes in specific regions and may predict the potential magnitude and impact of such rare events. The disclosed techniques may also predict the likelihood of early material failure due to factors such as, but not limited to, fatigue, corrosion, or manufacturing defects. The disclosed techniques may create digital replicas of physical systems to simulate and predict potential failures, allowing for proactive maintenance and optimization. In all of the aforementioned areas, the disclosed techniques may accurately estimate the probability of failure for different scenarios. The disclosed techniques may also identify critical areas where preventive measures or additional safety measures may be needed.

In FIGS. 1 and 2, rare events estimation module 152 is illustrated and described as executed by RL system 100. However, in some examples, a separate computing system may execute rare events estimation module 152 and communicate a control function or instructions to implement a control function to AI agent 102, receive data from RL system 100, and otherwise communicate with RL system 100 to implement techniques of this disclosure. RL system 100 may in such examples be considered a device under test (DUT). When deployed to production, RL system 100 in such examples would not include a rare events estimation module 152.

FIGS. 3A and 3B are graphs illustrating the computational challenge of simulating rare events. Rare events are occurrences with extremely low probabilities, often less than one in a million. In many real-world systems, such as engineering, finance, and climate science, these rare events may have significant consequences. For example, in engineering, a rare event may be a catastrophic failure of a critical component.

Monte Carlo methods are a class of computational algorithms that rely on repeated random sampling to obtain numerical results. Monte Carlo methods are useful for problems that are difficult to solve analytically. In the context of rare event simulation, Monte Carlo methods may involve simulating a large number of random scenarios and observing how often the rare event occurs. In other words, the challenge with using Monte Carlo methods to simulate rare events is the sheer number of simulations required to obtain accurate statistics. If an event has a probability of 10⁻⁶, on average, such an event will occur once in every million simulations.

To get a reliable estimate of this probability, the simulation system may need to run millions or even billions of simulations.

The reason for this large number of simulations is statistical. To ensure that the computed estimate of the rare event probability is accurate, the simulation system may need a sufficient number of samples from the region of interest. This region 304, shown in FIG. 3B, is refereed to hereinafter as the “failure region,” and may be extremely small as compared to the entire sample space. To get a good representation of the failure region 302, the simulation system may need to generate a large number of samples that fall within that region 302.

The computational cost of running such a large number of simulations may be prohibitive, especially for complex systems. The simulation system (e.g., rare events estimation module 152) may need O (10⁸-10⁹) samples to generate accurate statistics in the failure region 304. In other words, the computational complexity grows exponentially with the rarity of the event.

To address the computational challenge of simulating rare events, the rare events estimation module 152 may, for example, bias the simulation to focus on the regions of interest, increasing the probability of observing rare events. An event is rare when events of that type have a low probability. The probability that determines whether an event associated with a machine learning system is rare can depend on context of the system deployment and subjective factors. The probability may be determined by an operator, evaluator, or testing system. The threshold for a low probability that determines whether an event is rare may be 10⁻⁶ or lower.

The disclosed rare events estimation module 152 may use advanced statistical techniques to efficiently sample from the tail of the distribution 306, where rare events occur.

Relative error may be defined using the following equation (1):

$$ϵ = \frac{\sqrt{var [ ρ ]}}{ρ} \approx \frac{1}{\sqrt{N ρ}} \qquad ( 1 )$$

The equation (1) may be used in the context of Monte Carlo simulations, specifically when dealing with rare events or failures. ∈ represents the relative error, which may be a measure of how accurate the Monte Carlo simulation estimate is as compared to the true value.

var[ρ] is the variance of the quantity that is being simulated, ρ. In other words, the variance measures how spread out the values of ρ are in a particular simulation. ρ is the quantity being estimated by the simulation system (e.g., rare events estimation module 152). This quantity could be a probability, a failure rate, or any other relevant metric. N is the number of samples in the Monte Carlo simulation. In other words, equation (1) indicates that a relative error may be defined as the ratio of the absolute error to the true value.

In the context of Monte Carlo simulations, the true value may be often unknown, so the simulation system may use the estimated value from the simulation instead. Relative error is a dimensionless quantity, making it easier to compare the accuracy of simulations with different scales. In some cases, the relative error may provide a better sense of the significance of the error relative to the estimated value. For example, a small absolute error may be significant if the true value is also small.

A simulation system may run Monte Carlo simulation to obtain an estimate of ρ. Next, the simulation system may compute the variance of the simulated values of ρ. The simulation system may use the equation (1) above to calculate the relative error based on the estimated variance and the number of samples. A smaller relative error may indicate a more accurate simulation. However, it should be noted that the accuracy of the simulation may also depend on the quality of the simulation model and input parameters.

A general principle of Monte Carlo simulations is that the system needs

$$O ( \frac{1}{ρ} )$$

samples to keep error constant, particularly when dealing with rare events. In other words, the error in a Monte Carlo simulation is inversely proportional to the square root of the number of samples.

Additionally, to maintain a constant error, the simulation system may need to increase the number of samples proportionally to the inverse of the probability of the rare event (ρ). In other words, as the probability of the rare event (ρ) decreases, the simulation system may need to exponentially increase the number of samples to keep the error under control.

The Freidlin-Wentzell theory describes the behavior of rare events in stochastic systems. The Freidlin-Wentzell theory states that the probability of a rare event decays exponentially with the “action” or “cost” associated with that event. In the context of Monte Carlo simulations, this means that as the system moves further into the tail of the distribution 306 (i.e., as the probability of the event decreases), the computational effort required to sample from that region may increase exponentially because the simulation system may need to generate more samples to capture the rare events with low probability.

A combination of the aforementioned concepts illustrates that there is a trade-off between the desired accuracy (error) and the computational cost (effort). To achieve a certain level of accuracy for rare events, the rare events estimation module 152 may need to balance the increased number of samples and improvement of the efficiency of the sampling method. While increasing the number of samples may reduce the error, but such an increase may also increase the computational cost. Improving the efficiency of the sampling method may help reduce the computational cost without sacrificing accuracy.

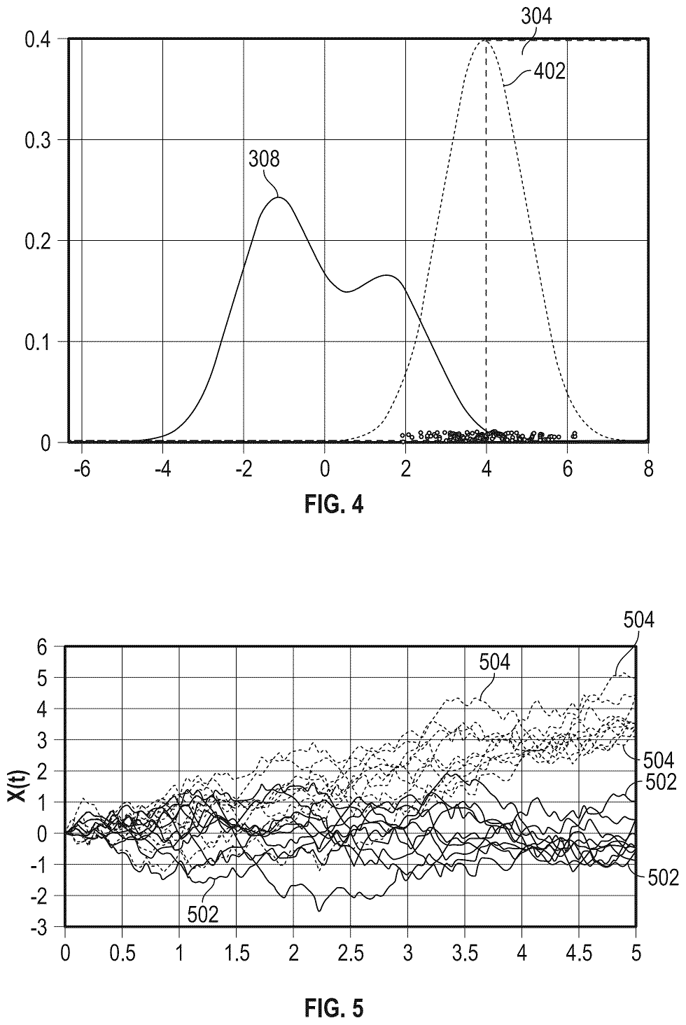

FIG. 4 illustrates static importance sampling, according to techniques described in this disclosure. It should be noted, when simulating rare events, directly sampling from the original distribution (e.g., distribution 308 shown in FIG. 3B) may be inefficient because most samples will fall outside the region of interest (e.g., failure region 304), wasting computational resources.

To address the aforementioned problem, the rare events estimation module 152 may employ importance sampling, which may introduce a biasing distribution 402 that is designed to concentrate samples in the region of interest (e.g., failure region 304). The rare events estimation module 152 may select the biasing distribution 402, denoted as g(x), that is easier to sample from and places more weight on the failure region 304. The biasing distribution 402 should ideally mimic the shape of the original distribution ƒ(x) in the tail region. Next, the rare events estimation module 152 may generate samples, x, from the biasing distribution g(x). The rare events estimation module 152 may assign each sample x an importance weight, w(x), which may be defined as the ratio of the original probability density function (PDF) to the biasing PDF.

According to the disclosed techniques, a well-chosen biasing distribution 402 may significantly reduce the variance of the estimator, leading to more accurate results with fewer samples. As noted above, the biasing distribution 402 should be easy to sample from and should mimic the shape of the original distribution 308 in the tail region 306. In this example, in the context of AI, a poor choice of biasing distribution 402 may actually increase the variance.

Importance weights (shown as weights 216 in FIG. 2) may account for the difference between the original distribution 308 and biasing distribution 402. Furthermore, samples with higher weights 216 may contribute more to the estimate. Importance sampling may significantly reduce the variance of the estimator, especially for rare events.

The variable representing a probability may be calculated by the rare events estimation module 152 using the following equation (3):

$$ρ = ℙ ( X > a ) \qquad ( 3 )$$

The equation (3) is a common representation in probability theory and statistics. In this example, ρ (“rho”) is a variable representing a probability.

[symbol] (X>α) represents the probability that a random variable X takes on a value greater than a certain threshold, denoted by “α.” The equation (3) states that the probability “ρ” is equal to the likelihood that a random variable “X” will have a value that exceeds a specific value “α.”

To illustrate with a concrete example, X may represent the heights of people in a population. α could be a specific height, like 6 feet. Then, ρ would represent the probability that a randomly selected person from this population is taller than 6 feet.

The value of ρ will always be between 0 and 1, inclusive. A higher value of ρ indicates a greater likelihood of the event occurring.

The probability of a rare event using Monte Carlo simulation may be estimated using equation (4):

$$\begin{matrix}\hat{ρ} = \frac{1}{M} {\sum }_{i = 1}^{M} {\{ X > a \}}_{} \\ = \frac{\# samples > a}{\# total samples}\end{matrix} \qquad ( 4 )$$

The equation (4) estimates the probability \hat{ρ} by averaging an indicator function over M samples. The indicator function [symbol] _{{X>α}} is 1 if the sample Xᵢ exceeds the threshold α, and 0 otherwise. In simpler terms, this equation counts the number of samples greater than α and divides by the total number of samples.

As noted above, the variance measures how spread out the estimates are likely to be. A lower variance indicates that the estimates are more concentrated around the true value. The relative error of the probability may be estimated using the following equation (5):

$$\frac{\sqrt{Var [ \hat{ρ} ]}}{ρ} \approx \frac{1}{\sqrt{M ρ}} \qquad ( 5 )$$

The relative error of the probability is the standard deviation of the estimate divided by the true probability. A lower relative error indicates a more accurate estimate.

In an aspect, the rare events estimation module 152 may estimate a probability using importance sampling by the following equation (6)

$$ρ \approx \frac{1}{M} {\sum }_{i = 1}^{M} \frac{η ( {\tilde{X}}_{i} )}{π ( {\tilde{X}}_{i} )} {𝟙}_{\{ \tilde{X} > a \}} \qquad ( 6 )$$

where
ρ is the estimated probability,
M is the number of samples in the Monte Carlo simulation,
\tilde{X}ᵢ represents the i-th sample drawn from the biasing distribution 402,
η(\tilde{X}ᵢ) is the probability density function (PDF) of the original distribution 308 evaluated at the sample \tilde{X}ᵢ ,
π(\tilde{X}ᵢ) is the probability density function (PDF) of the biasing distribution 402 evaluated at the sample \tilde{X}ᵢ, [symbol]
_{{\tilde{X}>α}} is an indicator function that is 1 if \tilde{X}ᵢ is greater than the threshold α, and 0 otherwise.

In the example illustrated in FIG. 4, instead of directly sampling from the original distribution 308 (η), the rare events estimation module 152 employing importance sampling may sample from biasing distribution 402 π. This proposal distribution is chosen to be easier to sample from and to concentrate samples in the region of interest (in this case, where \tilde{X}>α).

In this case, each sample \tilde{X}ᵢ is assigned a weight η(\tilde{X}ᵢ)/π(\tilde{X}ᵢ). This weight 216 accounts for the difference between the original distribution 308 and the biasing distribution 402. Samples from regions where the proposal distribution overestimates the original distribution will have lower weights, and vice versa.

In an aspect, the rare events estimation module 152 may calculate the estimated probability ρ by taking the average of the weighted indicator functions over all samples. More specifically, importance sampling may significantly improve the efficiency of Monte Carlo simulations for rare events by focusing sampling effort on the region of interest. The importance sampling may be applied to a wide range of distributions and problems.

FIG. 5 illustrates importance sampling for diffusions, according to techniques described in this disclosure. The Girsanov transformation is a tool in stochastic calculus that allows changing the measure of a stochastic process. Importance sampling, as discussed earlier, is a technique where the proposal distribution (e.g., biasing distribution 402) is sampled and then the samples are reweighted to estimate the quantity of interest. The Girsanov transformation may be used to reweight the samples in dynamic settings.

One technique to constructing the biasing distribution 402 is to use large deviation theory. Large deviation theory provides a way to estimate the probability of rare events by analyzing the exponential decay rate of the probability of such events. It should be noted that in the context of importance sampling, large deviation theory may be used to construct a biasing distribution that is tailored to the specific rare event of interest.

However, these techniques often lead to the solution of Hamilton-Jacobi partial differential equations (PDEs), which may be computationally expensive. These PDEs describe the optimal biasing distribution 402 that minimizes the variance of the importance sampling estimator. While large deviation theory is a useful technique, there are other techniques for constructing biasing distributions 402. Adjoint methods involve solving an adjoint PDE to obtain the optimal biasing distribution 402.

It should be noted that machine learning algorithms may be used to learn the optimal biasing distribution from data. The Girsanov transformation allows the rare events estimation module 152 to change the measure of a stochastic process, enabling the rare events estimation module 152 to construct new dynamical systems for importance sampling.

Large deviation theory provides a theoretical framework for designing optimal biasing distributions 402. However, solving the resulting Hamilton-Jacobi PDEs may be computationally expensive.

The following equations illustrate the biasing. The original stochastic process may be described by equation (7):

$${dX}_{t} = A ( {X}_{t} ) d t + B ( {X}_{t} ) d {W}_{t} \qquad ( 7 )$$

where
Xₜ is the state of the system at time t,
A(Xₜ) is the drift term, representing the deterministic part of the evolution,
B(Xₜ) is the diffusion term, representing the stochastic part of the evolution, dWₜ represents a random noise term (a Wiener process).

The modified dynamics process 504 may be described by equation (8):

$$d {\tilde{X}}_{t} = [ A ( {\tilde{X}}_{t} ) + B ( {\tilde{X}}_{t} ) u ( t , {\tilde{X}}_{t} ) ] d t + B ( {\tilde{X}}_{t} ) d {W}_{t} \qquad ( 8 )$$

Here, a new control function u (t, \tilde{X}ₜ) modifies the drift of the original process. This new process is denoted by \tilde{X}ₜ.

The likelihood ratio (Girsanov transformation) may be represented using equation (9):

$$Z ( {\tilde{X}}^{i} ) = exp [ - {\int }_{0}^{T} ( u ( s , {\tilde{X}}_{s} ) , d {W}_{s} 〉 - \frac{1}{2} {\int }_{0}^{T} {‖ u ( s , {\tilde{X}}_{s} ) ‖}^{2} ds ] \qquad ( 9 )$$

The likelihood ratio Z(\tilde{X}ⁱ) is a quantity that relates the probability measures of the original 502 and modified dynamics 504 processes. In one possible implementation, the likelihood ratio may be used to reweight the samples generated from the modified dynamics process 504 to obtain unbiased estimates for quantities of interest under the original process. Biasing methods may allow the rare events estimation module 152 to change the drift of a stochastic process by introducing a control function u(t, \tilde{X}ₜ). The rare events estimation module 152 may use the likelihood ratio Z(\tilde{X}ⁱ) to reweight samples from the modified dynamics process 504 to obtain unbiased estimates under the original process 502.

The Kolmogorov Backward Equation (KBE) is a partial differential equation (PDE) that governs the time evolution of the probability density function of a stochastic process. In the context of rare event simulation, the KBE provides a tool for designing various importance sampling schemes. The KBE describes how the probability of a rare event changes moving backward in time. By solving this equation, information about the most likely paths that lead to the rare event may be obtained. This information may be used to construct the biasing distribution 402 that focuses the sampling effort on these likely paths, thereby significantly improving the efficiency of biased Monte Carlo simulations.

Dynamic biasing is a technique that involves continuously adjusting the sampling distribution as the simulation progresses. Dynamic biasing allows adaptation to the evolving dynamics of the system and focus on the promising regions of the state space.

It should be noted that by solving the KBE, the rare events estimation module 152 may obtain the optimal biasing function 402, which may be used to modify the drift term of the stochastic differential equation (SDE) that governs the process. While the KBE provides an exact solution for the optimal biasing function, solving the KBE analytically is often challenging, especially for complex systems.

Various numerical methods and approximations may be employed to obtain practical KBE solutions. Finite difference methods discretize the time and space domains and approximate the derivatives in the KBE using finite difference formulas. Finite element methods represent the solution as a linear combination of basis functions and solve the resulting system of equations. Monte Carlo simulations may be used to estimate the solution of the KBE as well. The KBE is a PDE that describes the evolution of statistics of a stochastic process. In the context of rare event simulation, the KBE explains how the probability of a rare event changes as moving backward in time. The problem of estimating a rare event probability may be embedded into a PDE framework. A function Φ(t, x) may be defined, which represents the expected value of a function ƒ(Xₜ) at time T, given that the process is at state x at time t. This function satisfies the following linear PDE (10):

$$\{ \begin{matrix}{\partial }_{t} Φ ( t , x ) + 𝒜Φ ( t , x ) & = 0 \\ Φ ( T , x ) & = f ( x )\end{matrix} \qquad ( 10 )$$

where [symbol] is an operator defined as:

$$A ψ = 〈 A ( x ) , ∇ ψ 〉 + \frac{1}{2} T r [ B {B}^{*} {∇}^{2} ψ ]$$

Here, A(x) is the drift term of the stochastic process, BB is the diffusion term, and ∇ and ∇² are the gradient and Laplacian operators, respectively. The probability of the rare event w, ρ, is given by Φ(0, x), where x is the initial state of the process. In this example, solving the KBE exactly enables the rare events estimation module 152 to obtain the probability of the rare event without resorting to Monte Carlo simulation because the solution to the KBE provides with the exact probability distribution of the process at any time t. The Doob transform is a technique used in stochastic calculus to change the measure of a stochastic process. This transformation is useful in rare event simulation to improve the efficiency of Monte Carlo methods. The original stochastic process 502 may be described by equation (7) above. The modified dynamics process 504 may be described by equation (8) above. The equation (8) uses a control function u(t, \tilde{X}ₜ), which modifies the drift of the original stochastic process 502. This new process is denoted by \tilde{X}ₜ. The rare events estimation module 152 may first identify the specific region in the state space where the rare events are likely to occur. This step may involve analyzing historical data, domain expertise, or statistical techniques. The rare events estimation module 152 may determine a control function that guides AI agent 102 towards this rare region. The control function may act as a “steering wheel,” directing the behavior of AI agent 102 to explore the less frequent areas of the state space. In an aspect, rare events estimation module 152 may determine the control function using a Dood transform, The Doob transform involves selecting the control function u(t, \tilde{X}ₜ), as equation (11):

$$u ( t , x ) = {B ( x )}^{*} ∇ [ log Φ ( t , x ) ] \qquad ( 11 )$$

where Φ(t, x) is the solution to the Kolmogorov backward equation associated with the original stochastic process 502. With this choice of u(t, \tilde{X}ₜ), the likelihood ratio between the original stochastic 502 and modified dynamics 504 processes becomes a constant, resulting in a zero-variance estimator for the rare event probability. The zero-variance estimator may be expressed by formula (12):

$$ρ = f ( {\tilde{X}}_{T} ) Z ( \tilde{X} ) ( a . s . ) \qquad ( 12 )$$

The rare events estimation module 152 may influence the behavior of AI agent 102 using the modified dynamics to simulate behavior of AI agent 102 to produce events that can be sampled to generate one or more samples. This simulation may generate multiple trajectories or sample paths. Due to the modified dynamics, these simulations are more likely to produce samples that visit the rare region. The Doob transform may provide a way to construct an importance sampling scheme that is asymptotically optimal. In other words, the Doob transform may minimize the variance of the estimator as the number of samples increases. This technique is particularly useful for rare event simulation, where traditional Monte Carlo methods may be inefficient due to the low probability of the events of interest. By using the Doob transform, the rare events estimation module 152 may focus the sampling effort on the regions of the state space that are most likely to lead to the rare event, thereby improving the efficiency of the simulation. The rare events estimation module 152 may assign weights to each generated sample, as discussed above in conjunction with FIG. 4. The assigned weights may account for the fact that the samples were generated from a modified probability distribution. This may be important for accurate probability estimation. In one example, each sample \tilde{X}ᵢ may be assigned a weight η(\tilde{X}ᵢ)/π(\tilde{X}ᵢ). This weight 216 accounts for the difference between the original distribution 308 and the biasing distribution 402. Samples from regions where the proposal distribution overestimates the original distribution will have lower weights, and vice versa.

The Koopman operator, a tool in dynamical systems theory, may provide a linear perspective on nonlinear dynamics. Stochastic counterpart of the Koopman operator, the stochastic Koopman operator, extends this concept to systems influenced by noise or randomness. The Koopman operator has connections to the KBEs described above. In an example, the Koopman operator may linearize nonlinear dynamics by lifting the state space to a higher-dimensional space of observable functions. Similarly, the stochastic Koopman operator may linearize stochastic nonlinear dynamics, transforming the complex, nonlinear stochastic process 502 into a linear evolution of observable functions. As noted above, KBE describes the time evolution of the PDF of the original stochastic process 502. The stochastic Koopman operator may be used to analyze the evolution of observables of the original stochastic process 502, which are often related to moments or other statistical properties of the PDF. In this sense, the stochastic Koopman operator may provide insights into the dynamics of the PDF itself. Koopman mode decomposition technique decomposes the dynamics of a system into a sum of modes, each associated with a specific frequency and damping rate. By applying KMD to the stochastic Koopman operator, the rare events estimation module 152 may analyze the spectral properties of the stochastic system, such as AI agent 102, including the decay rates of fluctuations and the dominant modes of variation. By identifying the dominant Koopman modes, the rare events estimation module 152 may reduce the dimensionality of the stochastic system, leading to simplified models. The linear structure provided by the Koopman operator may be exploited to design control strategies for stochastic systems. Analyzing the spectral properties of the stochastic Koopman operator may help the rare events estimation module 152 quantify uncertainty in the behavior of AI agent 102.

As noted above the stochastic Koopman operator is a mathematical tool that may help to explain the behavior of nonlinear dynamical systems that are subject to random fluctuations or noise. The stochastic Koopman operator accomplishes this by transforming a complex, nonlinear system into a simpler, linear system. The Stochastic Differential Equation (SDE), such as equation (7) above may describe the evolution of AI agent 102 over time. An observable function, ƒ(x), is a quantity that the rare events estimation module 152 may measure or observe in AI agent 102. Examples of observables may include, but are not limited to the position of a vehicle, the outside temperature, or the concentration of a chemical. The stochastic Koopman operator, denoted as [symbol] ^{t} ƒ(x) is defined as the expected value of the observable function ƒ(Xₜ) at time t, given an initial condition X₀=x. Mathematically, the Stochastic Koopman operator may be represented by equation (13):

$${𝒦}^{t} f ( x ) = 𝔼 [ f ( {X}_{t} ) \vert {X}_{0} = x ] \qquad ( 13 )$$

The stochastic Koopman operator is linear. In other words, the stochastic Koopman operator satisfies the property of superposition. This linearity makes the stochastic Koopman operator easier to analyze and manipulate. If ϕ(x) is an eigenfunction of the stochastic Koopman operator, then applying the operator to ϕ(x) simply scales the function by a factor e^{μt}, where μ is the corresponding eigenvalue. This property may allow the rare events estimation module 152 to decompose the dynamics of AI agent 102 into simpler components.

The following equation (14) relates the Stochastic Koopman Operator (SKO) to the backward evolution operator:

$${lim}_{t \to 0} \frac{𝔼 [ f ( {X}_{t} ) \vert {X}_{0} = x ] - f ( x )}{t} = 〈 A ( x ) , ∇ f ( x ) 〉 + \frac{1}{2} T r [ B ( x ) {B ( x )}^{*} {∇}^{2} f ] \qquad ( 14 )$$

The Left-Hand Side (LHS) part

$$( {lim}_{t \to 0} \frac{𝔼 [ f ( {X}_{t} ) \vert {X}_{0} = x ] - f ( x )}{t} )$$

calculates the derivative of the expected value of an observable function ƒ(Xₜ) at time t, given an initial state X₀=x, with respect to time t. The LHS explains how the expected value of the observable changes as time progresses. The Right-Hand Side (RHS) part involves two terms—the drift term and the diffusion term. This drift term ( [symbol] A(x), ∇ƒ(x) [symbol] ) represents the deterministic part of the dynamics of AI agent 102. This term is the gradient of the observable function ƒ(x) multiplied by the drift term A(x) from the SDE. The diffusion term

$$( \frac{1}{2} T r [ B ( x ) {B ( x )}^{*} {∇}^{2} f ] )$$

accounts for the stochastic fluctuations in the behavior of AI agent 102. The diffusion term involves the trace of the product of the diffusion term B(x) from the SDE and the Hessian matrix of the observable function. The equation (14) states that the generator of the stochastic Koopman semigroup is equal to the backward evolution operator. In other words, this connection may be important because this connection allows the rare events estimation module 152 to leverage the properties of the SKO to study the dynamics of the behavior of AI agent 102.

Koopman numerical methods are techniques that may be used to analyze dynamical systems. The eigenfunctions of the backward evolution operator provide valuable information about the long-term behavior of AI agent 102. In this case, by using the eigenfunctions of the SKO, the rare events estimation module 152 may obtain approximate solutions to the Kolmogorov Backward Equation (KBE), which describes the evolution of probability densities in AI agent 102.

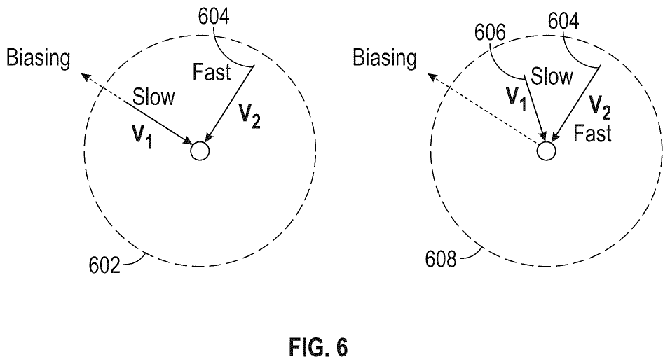

FIG. 6 illustrates comparison of dynamic importance sampling in normal and non-normal systems, according to techniques described in this disclosure.

In the realm of large deviations theory, when dealing with “normal” systems 602 (those with dynamics dominated by a single mode), the normal system tends to evolve in the direction of the right eigenvector associated with the largest eigenvalue because this eigenvector represents the direction of fastest growth. Koopman theory extends this understanding to non-normal systems, where the dynamics are not solely determined by a single dominant mode. In non-normal systems, the push towards the right eigenvector of the fastest mode is not the sole determinant of system behavior. The Koopman techniques suggest that the system may also be pushed in directions orthogonal to the right eigenvectors of the faster modes. This counterintuitive behavior is possible due to the non-normality of the system, such as AI agent 102. Extended Dynamic Mode Decomposition (EDMD) is a technique that leverages the Koopman operator to analyze complex dynamical systems. By constructing a Koopman operator from data, EDMD may identify the dominant modes of the system, including those modes that are not easily captured by traditional linear analysis methods. EDMD may help identify the slow and fast modes of AI agent 102. Understanding these modes may help rare events estimation module 152 analyze the behavior of AI agent 102 and predict future evolution of the behavior of AI agent 102. The left circle 602 in FIG. 6 may represent a normal system where the dynamics are dominated by a single mode. The arrow 604 points in the direction of the right eigenvector, indicating the direction of fastest growth. The right circle 608 depicts a non-normal system where the dynamics are influenced by multiple modes. The arrows 604, 606, and 610 show that the system may be pushed in different directions, including those orthogonal 610 to the right eigenvectors 604 of the faster modes.

In summary, the equation (7) may represent the original dynamics of a behavior of a stochastic system, such as AI agent 102. The equation (8) introduces a control function u(t, Xₜ) to the system. This control function may influence the behavior of AI agent 102. The rare events estimation module 152 may be configured to estimate the expectation of f(Xₜ) at the final time T, given the initial state X₀. In other words, the rare events estimation module 152 may calculate the stochastic Koopman operator may represented by the equation (13). To facilitate the estimation, the function ƒ(x) may be expressed as a linear combination of eigenfunctions ϕᵢ(x) using the following equation (15):

$$f ( x ) = {\sum }_{i = 1}^{N} {f}_{i} {ϕ}_{i} ( x ) \qquad ( 15 )$$

The KBE is a partial differential equation that governs the evolution of the conditional expectation. An approximate solution to the KBE may be expressed by the following equation (16):

$$\tilde{Φ} ( t , x ) = {\sum }_{i = 1}^{N} {f}_{i} {e}^{- {μ}_{i} ( T - t )} {ϕ}_{i} ( x ) \qquad ( 16 )$$

Here, μᵢ are the eigenvalues associated with the eigenfunctions ϕᵢ(x). The Doob transform is a technique used to modify the original dynamics to make the estimation process more tractable. The rare events estimation module 152 may calculate the biasing term u(t, x) using the gradient of the approximate solution \tilde{Φ}(t, x), expressed by the following equation (17):

$$u ( t , x ) = {B}^{*} ∇ log Φ ( t , x ) \qquad ( 17 )$$

The rare events estimation module 152 may add the biasing term to the original dynamics of the behavior of AI agent 102, leading to the modified dynamics, as shown in FIG. 5. Rare events estimation module 152 may influence the behavior of AI agent 102 using a control input u(t, x) to achieve a desired expected value at the final time. In other words, rare events estimation module 152 may alter the original dynamics of the behavior of AI agent 102 by incorporating the control function. This modification may bias the actions of AI agent 102 to increase the probability of entering the rare region. The Doob transform may provide a way to compute this control input based on the approximate solution to the KBE. Rare events estimation module 152 may communicate instructions, parameters, or other data to AI agent 102 to apply control input u to guide AI agent 102.

EVT is a statistical theory that studies the probabilities of rare events (e.g., floods, earthquakes). EVT interprets these events as limits of maximum and minimum values. The fundamental theorem of EVT states that extreme events for a random variable follow one of three distributions: Gumbel, Frechet, or Weibull. The exact distribution may depend on the tail behavior of the random variable. In an aspect, the rare events estimation module 152 may combine EVT with importance sampling, a model-based technique, to address the data-hungry nature of EVT. As noted above, importance sampling is a technique that may be used to estimate rare events. Importance sampling works by changing the probability distribution of the samples so that more samples are generated in the region of interest. The importance sampling may be used to guide AI agent 102 to failure states, which are often rare events. In an aspect, the rare events estimation module 152 may use fitting a GEV distribution after applying the Girsanov theorem. The Girsanov theorem is a mathematical theorem that may be used to change the probability measure of a stochastic process. The GEV distribution is particularly suitable for modeling extreme events because the GEV distribution may capture a wide range of tail behaviors. The GEV distribution is commonly used in fields like hydrology, finance, and climate science to analyze rare events. The overall techniques may use importance sampling to guide AI agent 102 to failure states and then fit a GEV distribution to the resulting data. These techniques may be used to estimate the probability of rare events, which may be important for risk assessment and decision-making. By focusing on the rare region, the disclosed techniques may significantly reduce the computational cost of estimating rare event probabilities. The control function may be adapted to different types of AI agents 102 and systems. The use of importance sampling and GEV distribution may help the rare events estimation module 152 to improve the accuracy of the probability estimates.

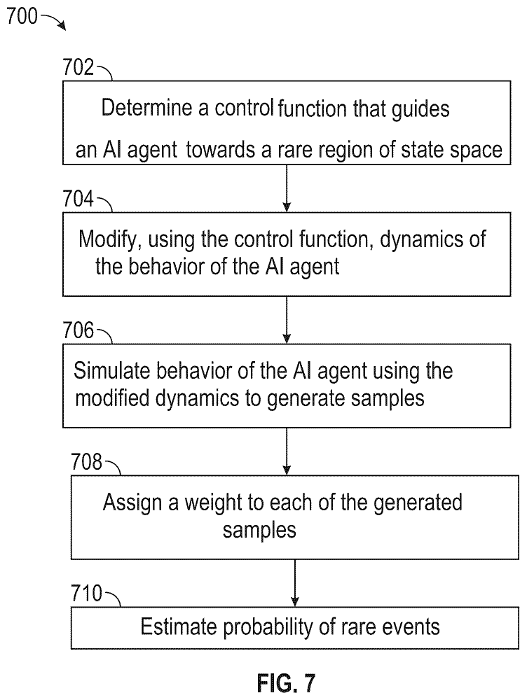

FIG. 7 is a flowchart illustrating an example mode of operation for a reinforcement learning system, according to techniques described in this disclosure. Although described with respect to computing system 200 of FIG. 2 having processing circuitry 243 that executes reinforcement learning system 100, mode of operation 700 may be performed by a computing system with respect to other examples of machine learning systems described herein.

In mode of operation 700, processing circuitry 243 executes reinforcement learning system 100. Rare events estimation module 152 may determine a control function u(t, \tilde{X}ₜ). that may guide AI agent 102 towards the rare region of state space (702). The control function is shown in the equation (8). In an aspect, this control function may influence the behavior of AI agent 102. The rare events estimation module 152 may modify, using the control function, dynamics of the behavior of AI agent 102 to generate modified dynamics (704). The modified dynamics process 504 may be described by equation (8) above. In an aspect, the equation (8) uses a control function u(t, \tilde{X}ₜ), which modifies the drift of the original stochastic process 502. In an aspect, the rare events estimation module 152 may employ the Doob transform, which is a technique used to modify the original dynamics to make the estimation process more tractable. The rare events estimation module 152 may add the biasing term to the original dynamics of the behavior of AI agent 102, leading to the modified dynamics, as shown in FIG. 5. Next, the rare events estimation module 152 may simulate behavior of AI agent 102 using the modified dynamics to generate one or more samples that are more likely to enter the rare region of the state space (706). Variance may measure how spread out the values of ρ are in a particular simulation. The rare events estimation module 152 may assign a weight to each of the one or more generated samples (708). The rare events estimation module 152 may assign each sample x an importance weight, w(x), which may be defined as the ratio of the original probability density function (PDF) to the biasing PDF. In an aspect, importance weights (shown as weights 216 in FIG. 2) may account for the difference between the original distribution 308 and biasing distribution 402. Advantageously, in accordance with the techniques described herein, by strategically weighting certain outcomes, the rare events estimation module 152 may focus on critical scenarios that might otherwise be overlooked. Finally, the rare events estimation module 152 may estimate probability of one or more rare events in the behavior of the AI agent by fitting a distribution describing behavior of the one or more rare events (e.g., a GEV distribution) to the one or more weighted samples (710).

In an aspect, by estimating the probability of rare events, the rare events estimation module 152 may quantify risks associated with autonomous systems, especially when deployed in critical infrastructure. By understanding the potential risks and their probabilities, organizations may make informed decisions about deployment and usage of various autonomous systems. For example, with respect to autonomous or semi-autonomous vehicles, the rare events estimation module 152 may quantify the likelihood of accidents due to sensor failures, software glitches, or adverse weather conditions. Based on that information, during deployment, autonomous driving may be limited to specific road conditions or geographic areas. As another non-limiting example, the rare events estimation module 152 may evaluate the risks of collisions, battery failures, or loss of signal for autonomous UAVs. Accordingly, the deployment strategies may include restricting flight operations to controlled airspace or specific time slots.

In another aspect, by estimating the probability of rare events, the rare events estimation module 152 may evaluate the potential consequences of rare events and may prioritize mitigation strategies. For example, a particular algorithms may be implemented that may allow the AI agent 102 to dynamically adjust its behavior based on real-time probability estimates. The AI agent 102 may be programmed to be more conservative in its actions when the probability of a rare event is high. In situations where the potential rewards outweigh the risks, AI agent 102 may be more aggressive, but with careful consideration of the probability of failure. As a non-limiting example, in the context of autonomous vehicles, behavior adjustment may include, but is not limited to: reducing speed of a vehicle, increasing sensor sensitivity and/or performing cautious maneuvers.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for estimation of the probability of rare events, the method comprising:
determining a control function that guides an Artificial Intelligence (AI) agent towards a rare region of state space;
modifying, using the control function, dynamics of the behavior of the AI agent to generate modified dynamics;
simulating behavior of the AI agent using the modified dynamics to generate one or more samples that are more likely to enter the rare region of the state space;
assigning a weight to each of the one or more generated samples; and
estimating probability of one or more rare events in the behavior of the AI agent by fitting a distribution describing behavior of the one or more rare events to the one or more weighted samples.

2. The method of claim 1, wherein modifying the dynamics of the behavior of the AI agent further comprises:
biasing sampling process, using importance sampling and biasing distribution of the behavior of the AI agent, to focus on the rare region of the state space of the AI agent that is more likely to lead to the one or more rare events.

3. The method of claim 2, wherein the sampling process comprises static importance sampling and wherein the method further comprises calculating the biasing distribution by:
calculating a likelihood ratio; and
reweighting, using the likelihood ratio, the one or more generated samples.

4. The method of claim 2, wherein the sampling process comprises dynamic importance sampling.

5. The method of claim 2, wherein the weight assigned to each of the one or more generated samples during reweighting accounts for a change between original distribution of the behavior of the AI agent and the biasing distribution.

6. The method of claim 5, wherein if a first sample has a higher weight than a second sample then the first sample contributes more to the estimated probability than the second sample.

7. The method of claim 1, wherein the one or more rare events comprise one or more failure modes of the AI agent.

8. The method of claim 1, wherein the distribution describing the behavior of the one or more rare events comprises a Generalized Extreme Value (GEV) distribution.

9. The method of claim 1, further comprising:
adjusting deployment strategy of the AI agent based on the estimated probability of the one or more rare events.

10. The method of claim 1, further comprising:
adjusting behavior strategy of the AI agent based on the estimated probability of the one or more rare events.

11. A computing system for estimation of the probability of rare events, the computing system comprising:
processing circuitry in communication with storage media, the processing circuitry configured to execute a machine learning system, the machine learning system configured to:
determine a control function that guides an Artificial Intelligence (AI) agent towards a rare region of state space;
modify, using the control function, dynamics of the behavior of the AI agent to generate modified dynamics;
simulate behavior of the AI agent using the modified dynamics to generate one or more samples that are more likely to enter the rare region of the state space;
assign a weight to each of the one or more generated samples; and
estimate probability of one or more rare events in the behavior of the AI agent by fitting a distribution describing behavior of the one or more rare events to the one or more weighted samples.

12. The system of claim 11, wherein the machine learning system configured to modify the dynamics of the behavior of the AI agent is further configured to:
bias sampling process, using importance sampling and biasing distribution of the behavior of the AI agent, to focus on the rare region of the state space of the AI agent that is more likely to lead to the one or more rare events.

13. The system of claim 12, wherein the sampling process comprises static importance sampling and wherein the machine learning system is further configured to calculate the biasing distribution by:
calculating a likelihood ratio; and
reweighting, using the likelihood ratio, the one or more generated samples.

14. The system of claim 12, wherein the sampling process comprises dynamic importance sampling.

15. The system of claim 12, wherein the weight assigned to each of the one or more generated samples during reweighting accounts for a change between original distribution of the behavior of the AI agent and the biasing distribution.

16. The system of claim 15, wherein if a first sample has a higher weight than a second sample then the first sample contributes more to the estimated probability than the second sample.

17. The system of claim 11, wherein the one or more rare events comprise one or more failure modes of the AI agent.

18. The system of claim 11, wherein the distribution describing the behavior of the one or more rare events comprises a Generalized Extreme Value (GEV) distribution.

19. The system of claim 11, wherein the machine learning system is further configured to:
adjust deployment strategy of the AI agent based on the estimated probability of the one or more rare events.

20. Non-transitory computer-readable storage media having instructions encoded thereon for estimation of the probability of rare events, the instructions configured to cause processing circuitry to:
determine a control function that guides an Artificial Intelligence (AI) agent towards a rare region of state space;
modify, using the control function, dynamics of the behavior of the AI agent to generate modified dynamics;
simulate behavior of the AI agent using the modified dynamics to generate one or more samples that are more likely to enter the rare region of the state space;
assign a weight to each of the one or more generated samples; and
estimate probability of one or more rare events in the behavior of the AI agent by fitting a distribution describing behavior of the one or more rare events to the one or more weighted samples.
